(19) United States
(12) Patent Application Publication
(10) Pub. No.: US 2022/0126674 A1
(43) Pub. Date: Apr. 28, 2022

(54) Hybrid Transmission Device and Motor Vehicle

(71) Applicant: ZF Friedrichshafen AG, Friedrichshafen (DE)

(72) Inventors: Stefan Beck, Eriskirch (DE); Fabian Kutter, Kressbronn (DE); Matthias Horn, Tettnang (DE); Thomas Martin, Weissensberg (DE); Michael Wechs, Weißensberg (DE); Johannes Kaltenbach, Friedrichshafen (DE); Martin Brehmer, Tettnang (DE); Peter Ziemer, Tettnang (DE); Thomas Kroh, Lindau (DE); Oliver Bayer, Hörbranz (AT); Max Bachmann, Friedrichshafen (DE)

(21) Appl. No.: 17/433,171

(22) PCT Filed: Oct. 15, 2019
(86) PCT No.: PCT/EP2019/077964

§ 371 Date: Aug. 23, 2021

(30) Foreign Application Priority Data
Mar. 5, 2019 (DE) 10 2019 202 972.8

(51) Int. Cl. B60K 6/547; B60K 6/387; B60K 6/36; B60K 6/48

(52) U.S. Cl. CPC B60K 6/547; B60K 6/387; B60K 6/36; F16H 2003/0826; B60Y 2200/92; B60K 2006/4825; B60K 6/48

(57) ABSTRACT

A hybrid transmission device (3) has at least one drive device (EM1, EM2), a first transmission input shaft (7), a second transmission input shaft (9), a first clutch (K1), and a connecting clutch (K3). The second transmission input shaft (9) is mounted on the first transmission input shaft (7). The connecting clutch (K3) is actuatable to rotationally fix the first transmission input shaft (7) to the second transmission input shaft (9). The first transmission input shaft (7) is connected to an output (6) of the first clutch (K1), where the at least one drive device (EM1, EM2), the connecting clutch (K3), and the first transmission input shaft (7) are connectable to an internal combustion engine (2) via actuation of the first clutch (K1), and where the first clutch (K1) is a dog clutch.

### CROSS-REFERENCE TO RELATED APPLICATION

The present application is related and has right of priority to PCT/EP2019/077964 filed on Oct. 15, 2019, which is related and has right of priority to German Patent Application No. 10 2019 202 972.8 filed Mar. 5, 2019, the entirety of which are incorporated by reference for all purposes.

### FIELD OF THE INVENTION

The invention relates to a hybrid transmission device with a first transmission input shaft and a second transmission input shaft mounted on the first transmission input shaft, wherein the first transmission input shaft is connected to an output of a clutch for connection to an internal combustion engine, the hybrid transmission device also has at least one electric motor, and a connecting clutch for the rotationally fixed connection of the first transmission input shaft and the second transmission input shaft.

### BACKGROUND

It is known to utilize hybrid transmission devices to reduce the CO2 emissions of motor vehicles. A hybrid transmission device is understood to be a transmission device, onto which an internal combustion engine and at least one further drive device are couplable. It is known to hybridize all automated transmissions, for example, automatic transmissions and dual clutch transmissions. DE10 2011 005 451 A1 describes a transmission, which includes two electric motors and has five forward gear ratios and one reverse gear ratio.

### SUMMARY OF THE INVENTION

On the basis thereof, the object of aspects of the present invention are to provide a hybrid transmission device, which is compact for front-transverse applications and offers even greater functionality.

As the solution to this problem, it is provided, in the case of a hybrid transmission device mentioned at the outset, that the clutch for connecting the first transmission input shaft and the internal combustion engine is a dog clutch. As a result, installation space is saved and the efficiency of the hybrid transmission device is improved.

The transmission of the hybrid transmission device is advantageously a gear change transmission. It has at least two discrete gear steps in this case.

Advantageously, the gear change transmission includes at least two sub-transmissions, in some embodiments, precisely two sub-transmissions. This allows for increased functionality and, for example, tractive force support during a gear change, in particular an internal-combustion-engine gear change as well as an electric gear change.

Preferably, at least one of the sub-transmissions is a gear change transmission. In particular, two or more sub-transmissions, in particular embodiments, precisely two sub-transmissions, are gear change transmissions. As such, one sub-transmission has at least two gear steps, and the further sub-transmission has at least one gear step.

Advantageously, one sub-transmission has precisely three gear steps, in particular three, forward gear steps. In addition, a second sub-transmission has precisely two gear steps, in particular two, forward gear steps.

Advantageously, the gear change transmission includes gearwheels and shift elements or engagement devices. The gearwheels are preferably spur gears.

Preferably, the transmission of the hybrid transmission device is a stationary transmission. In stationary transmissions, the axles of all gearwheels in the transmission are fixed in relation to the transmission housing.

Preferably, the gear change transmission is a transmission of a countershaft design. Preferably, the gear change transmission is a spur gear drive, where the gearwheels are spur gears.

In addition, in one example embodiment, the transmission is a dual clutch transmission, having two transmission input shafts.

In addition, the transmission preferably includes at least two transmission input shafts. Preferably, in some embodiments, the transmission includes precisely two transmission input shafts. With three or more transmission input shafts, although a larger number of sub-transmissions are producible, it has been proven that the described functionality is already achieved with two transmission input shafts.

Preferably, the first transmission input shaft is a solid shaft. Regardless of the design of the first transmission input shaft, the second input shaft is preferably mounted on the first transmission input shaft, i.e., it is arranged coaxially to the first transmission input shaft and encloses the first transmission input shaft. As such, the second transmission input shaft is a hollow shaft. The clutch for connecting the first transmission input shaft with an internal combustion engine and, advantageously, the clutch for connecting the second transmission input shaft with an internal combustion engine are also directly followed in the axial direction, on the engine side, by the second transmission input shaft.

Preferably, the hybrid transmission device includes at least one countershaft, in particular embodiments, precisely one countershaft. When a single countershaft is utilized, a single point of attachment to the differential is present. As a result, installation space in the radial direction, as well as in the axial direction, is saved.

Therefore, the transmission, in one preferred embodiment, includes precisely three shafts, namely two transmission input shafts and one countershaft, where the countershaft is also the output shaft in this case.

In an all-wheel variant of the transmission, one additional shaft is always added, which, as a power take-off, drives the second motor vehicle axle.

A gear step, as already described at the outset, is a mechanically implemented gear ratio between two shafts. The overall gear ratio between the internal combustion engine or the drive device and the wheel has further ratios, wherein the ratios upstream from a gear step, the so-called pre-ratios, depend on the output that is utilized. The post-ratios are usually identical. In an embodiment shown further below, the rotational speed and the torque of a drive device are transmitted or multiplied multiple times, namely by at least one gearwheel pair between the output shaft of the drive device and a transmission input shaft. This is a pre-ratio. This is followed by a gearwheel pair of a gear step with a ratio dependent on the gear step. Finally, this is followed by a gearwheel pair between the countershaft and the differential, as a post-ratio. A gear has an overall gear ratio that depends on the input and the gear step. Unless indicated otherwise, a gear or gear ratio relates to the utilized gear step.

Merely for the sake of clarity, it is pointed out that the ascending numbers of the gear steps refer, as usual, to a descending ratio. A first gear step G1 has a higher ratio than a second gear step G2, etc.

If torque is transmitted from the internal combustion engine via the first gear step G1, this is referred to as an internal-combustion-engine gear V1. If the second drive device and the internal combustion engine simultaneously transmit torque via the first gear step G1, this is referred to as a hybrid gear H11. If only the second drive device transmits torque via the first gear step G1, this is referred to as an electric gear E1.

In the following, gear steps refer to forward gear steps. Preferably, the transmission of the hybrid transmission device has at least three gear steps or gear stages. The gearwheels of a gear step are arranged in a gear plane when the gear step includes two gear-step gears. In a first embodiment, the transmission has at least four gear steps or gear stages. In a further embodiment, the transmission preferably has at least five gear steps or gear stages, in particular embodiments precisely five gear steps or gear stages.

Preferably, the transmission of the hybrid transmission device has one gear plane more than forward gear steps. In the case of five gears, this is six gear planes. The gear plane for attaching the drive output, for example, a differential, is included in the count.

In a first alternative, all gear steps are utilized in an internal combustion engine-driven and electric or fluidic manner. As a result, a maximum number of gears is obtained given a low number of gear steps. In a second alternative, at least one gear step, in particular embodiments, precisely one gear step, is reserved solely for a drive device of the hybrid transmission device, i.e., an electric gear step. In this embodiment, at least one other gear step is usable for transmitting torque of the internal combustion engine as well as of a drive device. Preferably, all further gear steps are usable for transmitting torque of the internal combustion engine as well as of a drive device.

Advantageously, the hybrid transmission device and/or the transmission is free from a reversing gearwheel for reversing the direction. Therefore, the reverse gear is not produced via the internal combustion engine, but rather via the electric motor or at least one of the electric motors. In this case, for example, the first gear step or the second gear step is utilized.

Preferably, gear-step gearwheels for all odd gear steps, in particular forward gear steps, are arranged on the first transmission input shaft. In addition, gear-step gears of all even gear steps, in particular forward gear steps, are preferably arranged at the second transmission input shaft. Gear-step gears, which are also referred to as gear-step gearwheels, are fixed gears or idler gears associated with a gear step.

Preferably, the highest even gear step and/or one of the gear-step gears associated therewith are/is located at the axial end of the transmission input shaft that supports one of the gear-step gearwheels of the highest even gear step. For instance, the highest even gear step is the fourth gear step and/or the transmission input shaft is the second transmission input shaft. Alternatively, the transmission input shaft is the first transmission input shaft.

Preferably, the highest odd gear step and/or one of the gear-step gears associated therewith are/is located at the axial end of the transmission input shaft that supports one of the gear-step gearwheels of the highest odd gear step. For instance, the highest odd gear step is the fifth gear step and/or the transmission input shaft is the first transmission input shaft.

Preferably, the highest electric gear step and/or one of the gear-step gears associated therewith are/is located at the axial end of the transmission input shaft that supports one of the gear-step gearwheels of the highest electric gear step. Preferably, the highest electric gear step is a second gear step and/or the transmission input shaft is the second transmission input shaft.

In a first embodiment, in sum, the gear-step gearwheels of the highest gear steps are located at the axial outer ends of the shafts, in particular of the transmission input shafts. If the transmission has five forward gear steps, the fourth gear step and the fifth gear step, i.e., the gearwheels thereof, are arranged axially externally and the other gear steps and their gearwheels are arranged within or between the fourth and fifth gear steps.

Preferably, the gear-step gears of the fourth gear step and of the second gear step are arranged on the second transmission input shaft from the outer side of the hybrid transmission device toward the inner side.

Alternatively, the gear-step gears of an electric gear step and of the first gear step are arranged on the second transmission input shaft from the outer side of the hybrid transmission device toward the inner side.

Preferably, the gear-step gears of the fifth gear step, of the first gear step, and of the third gear step are arranged on the first transmission input shaft from the outer side of the hybrid transmission device toward the inner side.

Alternatively, the gear-step gears of the fourth gear, of the second gear, and of the third gear are arranged on the first transmission input shaft from the outer side of the hybrid transmission device toward the inner side.

Preferably, the hybrid transmission device includes at least two drive devices, in particular embodiments, precisely two drive devices. An arrangement of one or multiple drive device(s) that act(s) at a certain point of the hybrid transmission device counts as a drive device. This means, for example, in an embodiment of the drive devices as electric motors, that multiple small electric motors are also considered to be one electric motor if their torque is summarized at a single starting point.

Advantageously, at least one drive device is associated with the first transmission input shaft as well as with the second transmission input shaft. The gears implemented via the first transmission input shaft and the gears implemented via the second transmission input shaft form a sub-transmission in each case. It may therefore also be stated that at least one drive device is associated with each sub-transmission. Preferably, the hybrid transmission device includes at least two sub-transmissions, in particular embodiments, precisely two, sub-transmissions.

Preferably, at least one of the drive devices is a generator.

Preferably, the first drive device and/or the second drive device are/is a motor and as a generator.

Preferably, the drive device is attached to the highest gear step of the transmission. In the case of two drive devices, it is advantageously provided, in a first embodiment, that they are attached to the two highest gear steps. In a further embodiment, it is provided that the drive devices are each attached to the highest gear step of a particular sub-transmission. The two highest gear steps are also arranged in a single sub-transmission. In addition, the drive devices are each attached to the highest gear steps on a transmission input shaft.

Preferably, the drive device is attached to an axially externally situated gear step, more precisely, to one of the gearwheels of the gear step, of the transmission. In the case of two drive devices, it is advantageously provided that both are attached to an axially externally situated gear step of the transmission. As a result, the center distance of the attachment points is maximized.

At this point, it is to be pointed out that, in the present invention, a connection or operative connection refers to any power flow-related connection, also across other components of the transmission. An attachment, however, refers to the first connecting point for transmitting drive torque between the prime mover and the transmission.

An attachment to a gear step, i.e., one of its gear-step gearwheels, takes place via a gearwheel. An additional intermediate gear may be necessary, in order to bridge the center distance between the output shaft of the drive device and the transmission input shaft. Due to the attachment of the drive device to a gear-step gearwheel, a further gear plane is avoided, which would be present only for attaching the drive device.

Advantageously, at least one of the axially external gear-step gears, which are arranged on the axis of the transmission input shafts, is a fixed gear. Preferably, both axially external gear-step gears are fixed gears. In this case, the drive devices are attached to a fixed gear on the first transmission input shaft and/or to a fixed gear on the second transmission input shaft. The drive devices are therefore preferably arranged in a so-called P3 arrangement, i.e., at the transmission gear set.

Preferably, a drive device is attached to the third gear stage. Alternatively, or additionally, a drive device is attached to the single electric gear step.

Alternatively, or additionally, a drive device is attached to the fourth gear step. Alternatively, or additionally, a drive device is attached to the fifth gear step.

Preferably, the first drive device is rotationally fixed to the internal combustion engine in all internal-combustion-engine forward gears and/or during an internal-combustion-engine gear change. In this case, a constant connection exists between the internal combustion engine and the first drive device during internal combustion engine-driven travel. Preferably, the first drive device is utilized, at least intermittently, as a generator in all forward gears except for the crawler gear.

Preferably, the second drive device is utilized for an electric or fluidic forward starting operation. In this case, the second drive device is coupled, advantageously, to the gear-step gears of the second gear. The starting operation is always performed by the second drive device. The second drive device is preferably utilized as a sole drive source for the starting operation. The second drive device is also utilized for electric or fluidic travel in reverse. Preferably, the second drive device is also the sole drive source during travel in reverse. In this case, there are no internal-combustion-engine or hybrid reverse gears.

Preferably, the drive devices are arranged axially parallel to the first transmission input shaft. They are then preferably also axially parallel to the second transmission input shaft and to the countershaft. In the present invention, an axially parallel arrangement refers not only to completely parallel arrangements, instead, an inclination or an angle between the longitudinal axis of the transmission input shafts and the longitudinal axis of the electric motor is also possible. Preferably, an angle is provided between the longitudinal axis of an electric motor and the longitudinal axis of the transmission input shafts of less than or equal to 10°, further preferably less than 5° and, in particular 0°. Slight inclinations of the drive devices in comparison to the transmission result for reasons related to installation space.

Preferably, the drive devices are counter-rotatingly arranged. This means, the output shafts of the drive devices point toward different, opposite sides. If the first drive device has its output side on the left, the second drive device has its output side on the right or, if the viewing direction is changed, one drive device has its output side at the front and the other drive device has its output side at the rear. As a result, the engagement point of the drive devices at the hybrid transmission device are axially spaced apart and improved coverage in the axial direction is achieved.

Preferably, the axes of the drive devices in the installation position are situated above the axis of the transmission input shaft. The installation position is always referenced in the following. During installation, the hybrid transmission device is upside down. Such positions are irrelevant for the following description, however. While the axially parallel arrangement also makes it possible for one of the drive devices to be located below the axis of the transmission input shaft, it is advantageously provided that the drive devices and, thereby, their axes are positioned above the transmission input shaft to maximize packing density.

In addition, the axes of the drive devices in the installation position are situated on both sides of the axis of the transmission input shaft. Therefore, one of the drive devices and/or its axis are/is situated to the left of the axis of the transmission input shaft and the other(s) are/is situated to the right of the axis. Reference is made here to the view of the axes in cross-section.

Preferably, it is provided that the axes of the drive devices in the installation position are arranged symmetrically with respect to the axis of the transmission input shaft. In particular, the axes of the drive devices are symmetrically arranged with respect to distance and angular position, wherein the angle is based on the perpendicular. The drive devices are counter-rotatingly arranged without ruining the symmetrical arrangement, since the position of the axes is all that matters.

Preferably, the axes of the drive devices in the installation position are situated above the axes of one or multiple countershaft(s) and/or one or multiple output shaft(s). The drive devices are therefore situated above the aforementioned components of the spur gear drive arrangement. Alternatively, it is therefore said that the axes of the drive devices in the installation position are the uppermost axes of the hybrid transmission device.

Preferably, the drive devices are arranged offset in the circumferential direction. The circumferential direction is established with respect to the longitudinal axis of the transmission input shaft, which, by definition, is considered in the present invention to be the longitudinal axis of the hybrid transmission device.

It is preferred when the drive devices are arranged at least partially overlapping in the axial direction. Preferably, the overlap in the axial direction is more than 75 percent. If the drive devices should be of unequal length, the shorter drive device is used as the basis for calculating the overlap. The overlap is determined with reference to the housing of the drive devices. The output shaft of the drive devices is not taken into account.

The drive devices are arranged in the axial direction preferably at the same level as the gear change transmission. Preferably, the overlap in the axial direction is more than 75%. Advantageously, the overlap in the axial direction is 100%. Here, the overlap is determined with reference to the housing of the drive devices and, in particular, of the housing of the longer drive device. The output shaft of the drive devices is not taken into account.

Preferably, the first drive device is rotationally fixed to the first transmission input shaft, in particular attached to the first transmission input shaft. When the first transmission input shaft is arranged such that it is connectable to the internal combustion engine by a single shift element, the first drive device is operable as a generator in many operating situations.

Advantageously, the second drive device is rotationally fixed to the second transmission input shaft, in particular attached to the second transmission input shaft. When the second transmission input shaft is arranged such that it is connectable to the internal combustion engine by two shift elements and, in particular, via the first transmission input shaft, the second drive device is utilized in many operating situations as a parallel drive source with respect to the internal combustion engine.

Preferably, the first drive device and/or the second drive device is an electric motor. Electric motors are widespread in hybrid transmission devices.

Alternatively, or additionally, the first drive device and/or the second drive device is a fluid power machine. In addition to electric motors, there are other prime movers or power machines, the utilization of which in hybrid transmission devices is conceivable. These are also operated as motors, i.e., in a manner that consumes energy, or as generators, i.e., in a manner that converts energy. In the case of a fluid power machine, the energy accumulator is, for example, a pressure reservoir. The energy conversion then consists of converting the energy from the internal combustion engine into a pressure build-up.

Advantageously, the first drive device and the second drive device are power-shiftable. A powershift is understood here, as usual, to mean that no interruption of tractive force occurs at the output of the hybrid transmission device during a gear change, for example, of the first drive device. A reduction of the torque present at the output is possible, but a complete interruption is not.

As a result, the motor vehicle is continuously driven in large speed ranges, for example, exclusively electrically, wherein the ratio, i.e., the gear, is selected in each case so as to be optimized with respect to the rotational speed and torque of the drive device.

Preferably, the second drive device outputs torque to the drive output while the first drive device is shifted. In other words, the gear step is changed, via which the first drive device transmits torque to the drive output.

Preferably, the first drive device outputs torque to the drive output while the second drive device is shifted. This means, the gear step is changed, via which the second drive device transmits torque to the drive output. It may therefore also be stated that the drive devices are power shiftable with one another. The internal combustion engine therefore does not need to be started for a gear change during electric travel.

Preferably, at least one of the drive devices is attached to the transmission via a P3 attachment. Advantageously, both drive devices are attached to the transmission via this attachment. In a P3 attachment, the drive devices engage at the transmission between the input shaft and the output shaft.

Advantageously, both drive devices are operatively connected to a differential via, at most, four meshing points. As a result, good efficiency is achieved.

The clutch for connecting the first transmission input shaft to an internal combustion engine is advantageously arranged at the end of the first transmission input shaft facing the outer side and the internal combustion engine of the hybrid transmission device.

In addition, a clutch is present for connecting the second transmission input shaft to the internal combustion engine. This is advantageously arranged at the end of the second transmission input shaft facing the outer side and the internal combustion engine of the hybrid transmission device.

The connecting clutch is utilized for coupling the sub-transmission. However, it is also a clutch for connecting the second transmission input shaft to the internal combustion engine, wherein the connection extends via the first transmission input shaft.

Preferably, the connecting clutch is arranged at the end of the second transmission input shaft facing the transmission. As a result, it becomes possible to provide two clutches on the engine side, with which the first transmission input shaft as well as the second transmission input shaft are connectable to the internal combustion engine. As a result, it becomes possible, for example, to provide an electric motor-operated crawler gear or also to operate both electric motors together and, alternately, as generators.

Advantageously, the connecting clutch is part of a two-sided engagement device. Due to its positioning, the connecting clutch is integratable into a two-sided engagement device.

In the present invention, an engagement device is understood to be an arrangement with one or two shift element(s). The engagement device is one-sided or two-sided. A shift element or engagement device is a clutch or a gearshift clutch. A clutch is utilized for operably connecting two shafts in a rotationally fixed manner and a gearshift clutch is utilized for operably, rotationally fixing a shaft to a hub rotatably mounted thereon, for example, an idler gear. The connecting clutch, therefore, a gearshift clutch and, preferably, also is part of a gearshift clutch and referred to as a clutch only because it connects two shafts to one another. The clutches for connecting the transmission input shafts to the internal combustion engine connect the particular transmission input shaft to a crankshaft of the internal combustion engine.

Preferably, at least a portion of the clutches and/or gearshift clutches are dog clutches. In particular, all clutches and gearshift clutches are dog clutches.

Advantageously, at least one engagement device is arranged on the first transmission input shaft. Preferably, at least two engagement devices, in particular embodiments, precisely two engagement devices, are arranged on the first transmission input shaft, such as a two-sided engagement device. Alternatively, a one-sided engagement device and a two-sided engagement device are provided. Advantageously, the engagement devices enclose the second transmission input shaft.

One of the engagement devices on the first transmission input shaft preferably includes a gearshift clutch and a clutch.

Advantageously, the second transmission input shaft is engagement device-free and/or idler gear-free. Preferably, at least one fixed gear is arranged on the second transmission input shaft. In particular, at least two fixed gears, in particular embodiments, precisely two fixed gears, are arranged on the second transmission input shaft.

Preferably, at least one idler gear, in particular embodiments precisely one idler gear, is arranged on the first transmission input shaft.

Preferably, at least two fixed gears, in particular embodiments, precisely two fixed gears, are arranged on the first transmission input shaft.

Advantageously, one fixed gear and one idler gear are associated with each forward gear step and, in fact, a single fixed gear and a single idler gear in each case. In addition, each fixed gear and idler gear are always unambiguously associated with a single forward gear step, i.e., there are no winding-path gears by utilizing one gearwheel for multiple gears. Nevertheless, the internal-combustion-engine forward gears two and four are considered to be winding-path or coupling gears, as described below, since the first transmission input shaft is interconnected during the formation of the gears.

In one preferred embodiment, the hybrid transmission device and/or the transmission includes precisely four two-sided engagement devices for producing five internal-combustion-engine gear stages, in particular forward gear stages. The connecting clutch advantageously forms part of one of the two-sided engagement devices.

Preferably, a differential is arranged in the axial direction at the level of one or two clutches for connecting a transmission input shaft to the internal combustion engine. Advantageously, a gearwheel for attaching the differential is arranged axially externally on a countershaft. The attachment preferably takes place at the side of the internal combustion engine.

Preferably, the hybrid transmission device includes at least one countershaft, in particular embodiments, precisely one countershaft. In the case that a single countershaft is utilized, a single point of attachment to the differential is present. As a result, installation space in the radial direction, as well as in the axial direction, is saved.

Preferably, at least two engagement devices, in particular embodiments, precisely two engagement devices, are arranged on the countershaft. In addition, advantageously, precisely four idler gears are arranged on the countershaft. Advantageously, all the engagement devices on the countershaft are two-sided.

The engagement devices arranged on the countershaft are arranged offset in the axial direction with respect to one or multiple engagement device(s) on one of the transmission input shafts, in particular the first transmission input shaft. In particular, the engagement devices on the countershaft enclose an engagement device on the first transmission input shaft in the axial direction. This means, they are not only axially offset, but rather that the one engagement device on the countershaft is located to the left of the engagement device on the first transmission input shaft and the other to the right thereof, as viewed in a gear set scheme. When the transmission is viewed in the direction longitudinally to the transmission, the one engagement device is situated in front of the engagement device and the other behind the engagement device on the first transmission input shaft. The enclosed engagement device is advantageously arranged at one end of the second transmission input shaft.

Advantageously, all shift elements of the engagement devices on the countershaft are gearshift clutches.

Preferably, at least one fixed gear, in particular embodiments, precisely one fixed gear, is located on the countershaft for forming a forward gear step. In addition, a fixed gear is located on the countershaft for establishing a connection to the differential. However, this is not a fixed gear for forming a forward gear step.

Advantageously, a single fixed gear for forming a forward gear step is arranged on the countershaft, and at least one idler gear is arranged on both sides of the fixed gear. Preferably, at least two idler gears, in particular embodiments, precisely two idler gears, are located on both sides of the fixed gear.

In addition, the hybrid transmission device includes a control device for controlling the transmission as described.

The invention also relates to a motor vehicle with an internal combustion engine and a hybrid transmission device, as described.

Advantageously, the hybrid transmission device is arranged in the motor vehicle as a front-transverse transmission device.

Preferably, the motor vehicle includes a control device for the open-loop control of the hybrid transmission device. The control device is therefore part of the hybrid transmission device, although it does not need to be.

Preferably, a battery is arranged in the motor vehicle, which allows for an electric operation of the motor vehicle for at least 15 minutes. Alternatively, for a purely electric operation, the internal combustion engine, with one of the electric motors as a generator, generates current, which goes directly to the other electric motor.

In addition, the motor vehicle includes a pressure reservoir for operating a fluid power machine.

### BRIEF DESCRIPTION OF THE DRAWINGS

Further advantages, features, and details of the invention result from the following description of exemplary embodiments and figures, in which:

FIG. 1 shows an example motor vehicle,

FIG. 2 shows a first example gear set scheme,

FIG. 3 shows a circuit diagram for the gear set scheme of FIG. 2,

FIG. 4 shows a first example shift pattern for the gear set scheme of FIG. 2,

FIG. 5 shows the hybrid transmission device in a side view,

FIG. 6 shows a circuit diagram for a crawler gear,

FIG. 7 shows a circuit diagram for a hybrid gear,

FIG. 8 shows a representation of a first gear change over time,

FIG. 9 shows a representation of a second gear change over time,

FIG. 10 shows a second example gear set scheme,

FIG. 11 shows a second example shift pattern, and

FIG. 12 shows a third example gear set scheme.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

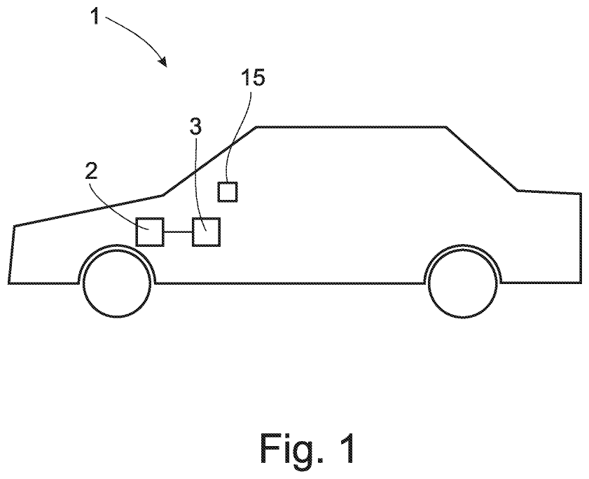

FIG. 1 shows a motor vehicle 1 with an internal combustion engine 2 and a hybrid transmission device 3. The hybrid transmission device 3 includes, as described in greater detail further below, electric motors and a clutch device, and is installed as an assembly unit. This is not absolutely necessary, however. For instance, in principle, the gear set forms an assembly unit even without a previously connected clutch assembly and the electric motors. A control device 15 is provided for the open-loop control of the hybrid transmission device 3. The control device 15 is part of the hybrid transmission device 3 or of the motor vehicle.

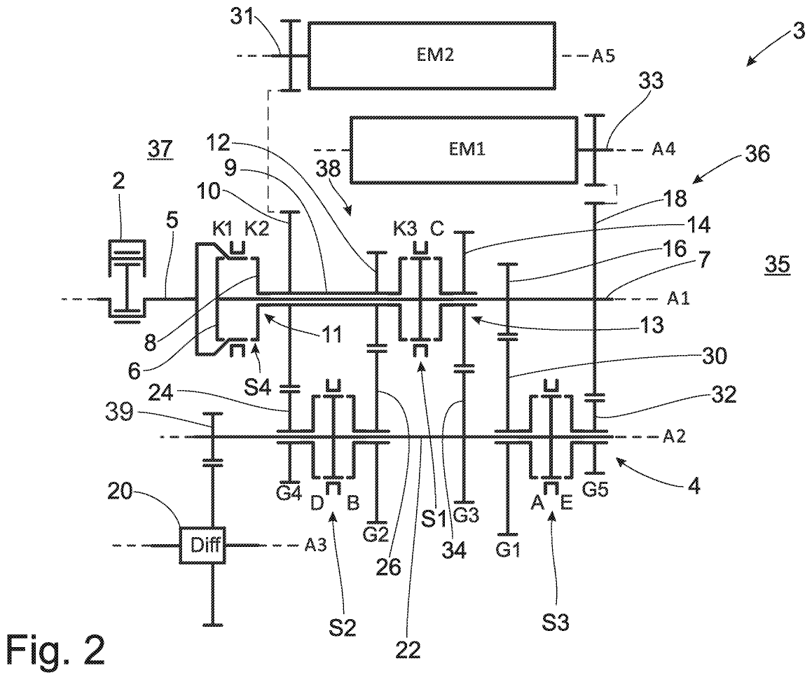

FIG. 2 shows one example embodiment of the hybrid transmission device 3 and, in particular, its gear change transmission 4, in the form of a gear set scheme. In the following, the hybrid transmission device 3 will be described starting from the internal combustion engine 2. A first clutch K1 and a second clutch K2 are attached, on their respective input-side, to a crankshaft 5. An output part or side 6 of the first clutch K1 is connected to a first transmission input shaft 7 and an output part or side 8 of the second clutch K2 is connected to a second transmission input shaft 9. A first fixed gear 10 and a second fixed gear 12 are arranged on the second transmission input shaft 9. The first fixed gear 10 is a fixed gear of a fourth gear step G4 and the second fixed gear 12 is a fixed gear of a second gear step G2.

The second transmission input shaft 9 has two ends, namely a first end 11 proximate or pointing toward an outer side 37 of the hybrid transmission device 3 and a second end 13 proximate or pointing toward an inner side 35 of the hybrid transmission device 3.

A first engagement device 51 is mounted on the transmission input shaft 7 for selectively engaging a third clutch K3 and a gearshift clutch C. A third idler gear 14 is rotationally fixable to the transmission input shaft 7 by the gearshift clutch C. The third idler gear 14 is an idler gear of a third gear step G3.

On the first transmission input shaft 7, a fourth fixed gear 16 and a fifth fixed gear 18 follow, wherein the fourth fixed gear 16 is a fixed gear of a first gear step G1 and the fifth fixed gear 18 is a fixed gear of a fifth gear step G5.

The second transmission input shaft 9 is therefore shift element-free and idler gear-free. The first engagement device 51 and a fourth engagement device S4 are arranged on the first transmission input shaft 7. The first engagement device 51 includes the third clutch K3 and the gearshift clutch C and, therefore, is two-sided.

The first transmission input shaft 7 and of the second transmission input shaft 9 rotate about a first axis of rotation A1.

The hybrid transmission device 3 includes a single countershaft 22 for connection to a differential 20 and to form the gear stages or gear steps. A second engagement device S2 and a third engagement device S3 are arranged on the countershaft 22 with first gearshift clutch A, second gearshift clutch B, fourth gearshift clutch D, and fifth gearshift clutch E for connecting a first idler gear 24, a second idler gear 26, a fourth idler gear 30, and a fifth idler gear 32 to the countershaft 22. As the only gear-implementing fixed gear, the third fixed gear 34 is located between the first, second, fourth, and fifth idler gears 24, 26, 30, and 32 on the countershaft 22. A sixth fixed gear 39 is not a gear-implementing fixed gear. The sixth fixed gear 39 connects the countershaft 22 to the differential 20 as a so-called drive output constant. On the basis of this scheme, the following is determined with respect to the forward gear steps:

One fixed gear and one idler gear are associated with each forward gear step and, in fact, a single fixed gear and a single idler gear in each case. Each fixed gear and idler gear pair are always unambiguously associated with a single forward gear step, i.e., there are no winding-path gears by utilizing one gearwheel for multiple gear steps. Nevertheless, the second and fourth forward gear steps G2, G4 are considered to be coupling gears, since the first transmission input shaft 7 is interconnected during the formation of the second and fourth forward gear steps G2, G4.

A first electric motor EM,1 and a second electric motor EM2 are attached as shown and at the first and fifth axially external gearwheels 10, 18, respectively. As a result, it is possible to attach the electric motors EM1, EM2 without additional gearwheels on one of the transmission input shafts 7, 9, as the result of which installation space is saved. In particular, due to the attachment of the electric motors EM1, EM2 at the axially outermost gearwheels 10, 18, an axially extremely short hybrid transmission device 3 is created.

The electric motors EM1, EM2 are arranged in parallel to the transmission input shaft 7 and the electric motors EM1, EM2 have their output at opposite sides. This means, as shown in FIG. 2, the output and/or the output shaft 33 of the first electric motor EM1 points toward the end 35 of the gear change transmission 4 facing away from the motor, and the output shaft 31 of the second electric motor EM2 points toward the end 37 of the gear change transmission 4 facing the motor. In FIG. 2, one end therefore points toward the left and one end points toward the right. The electric motors EM1, EM2 are arranged partially overlapping in the axial direction, and so the hybrid transmission device 3, in the area of the electric motors EM1, EM2, takes up only approximately the length occupied by a single electric motor. Due to the above-described arrangement of the engagement devices S1, S2, S3, S4 and t the reverse gear being without a reversing gearwheel, a length of the hybrid transmission device 3 of slightly more than 30 cm is made possible.

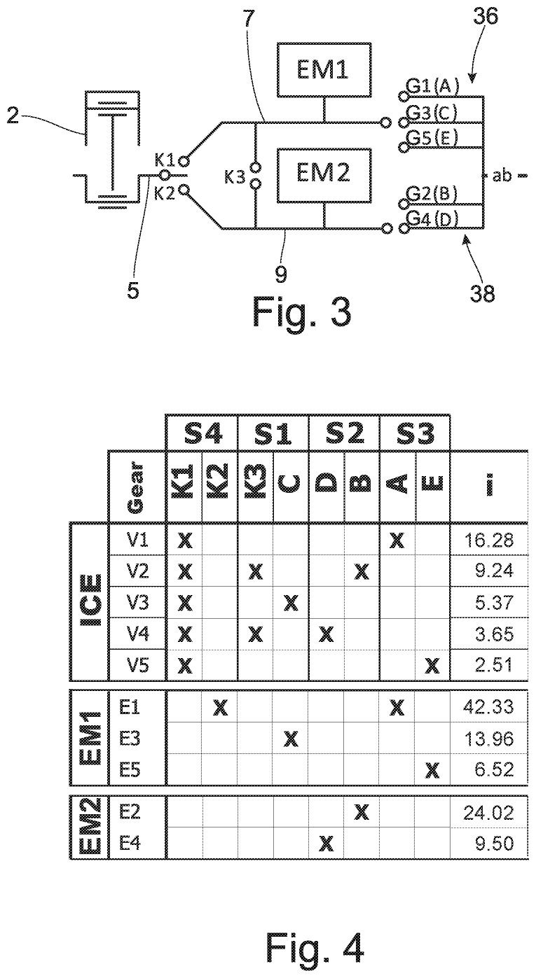

FIG. 3 shows a circuit diagram of the hybrid transmission device 3 according to FIG. 2, from which it arises, for example, that the third clutch K3 connects the input shafts 7, 9 of first and second sub-transmissions 36, 38. The first sub-transmission 36 includes the odd gears G1, G3, G5 and the second sub-transmission 38 includes the even gears G2, G4.

FIG. 4 shows a first shift pattern for the hybrid transmission device 3 according to FIG. 2, in which it is apparent that the first clutch K1 is engaged in all internal-combustion-engine gears V1, V2, V3, V4, V5. This also applies for the internal-combustion-engine forward gears V1, V2, V3, V4 of the embodiments described further below. In contrast to a typical dual clutch transmission, in which the first and second clutches K1, K2 are alternately disengaged and engaged during the shifting of the forward gears, the even-numbered internal-combustion-engine gears V2, V4 are achieved in that the first and third clutches K1, K3 are engaged. A changeover between the sub-transmissions therefore preferably takes place via the disengagement and engagement of the third clutch K3. In contrast to typical dual clutch transmissions, the utilization of the clutches is therefore implemented in a deviating manner. As is already also apparent from FIG. 2, precisely one of the gearshift clutches A, B, C, D, E is engaged and in the power flow in each of the internal-combustion-engine forward gears V1, V2, V3, V4.

The described hybrid transmission device 3 has several functional advantages. For example, due to the described arrangement, both electric motors are operable as a motor and as a generator. As a result, it is possible, for example, to provide a crawler gear E1 in the shift pattern for the electric motor EM1. The crawler gear E1 has a ratio of over 40. For this purpose, the second clutch K2 and the first gearshift clutch A are engaged. Since the crawler gear E1 produced with the hybrid transmission device 3 is formed via driving with the first electric motor EM1, the second electric motor EM2 is usable as a generator in the meantime. In the crawler gear E1, therefore, the first electric motor EM1 is utilized as a motor and the second electric motor EM2 is utilized as a generator.

This is also the sole utilization of the second clutch K2.

Of course, the crawler gear E1 is also operable in a battery electric manner. In this case, only the first gearshift clutch A is necessarily engaged and the second clutch K2 is engaged or disengaged.

In each of a third electric motor-operated forward gear E3 and a fifth electric motor-operated gear E5, one of the third gearshift clutch C or the fifth gearshift clutch E is engaged, as the result of which the described ratios are produced. In these gears as well, it is possible to engage the second clutch K2 and utilize the second electric motor EM2 as a generator.

With the second electric motor EM2, two electric motor-operated forward gears, including a second electric motor-operated forward gear E2 and a fourth electric motor-operated forward gear E4, are also produced. For this purpose, only the second transmission input shaft 9 and the second engagement device S2, with one of the second or fourth gearshift clutches B, D in each case, are utilized. In these gears, it is possible, therefore, to engage the first clutch K1 and utilize the first electric motor EM1 as a generator.

By the two electric motors EM1, EM2, five electric forward gears, including one crawler gear, are therefore formed, wherein only one of the two sub-transmissions 36, 38 must be integrated in each case.

The gearshift clutches A, B, C, D, E and at least the second and third clutches K2, K3 are advantageously dog clutches. Preferably, the first clutch K1 is also a dog clutch. An internal-combustion-engine gear change under load takes place by utilization of the electric motor(s) EM1, EM2.

The gear change from the first internal-combustion-engine gear V1 into the second internal-combustion-engine gear V2 is described in the following. In the first internal-combustion-engine forward gear V1, the first clutch K1 and the first gearshift clutch A are engaged. In addition, the second gearshift clutch B is engaged, but not yet loaded. Thereupon, the first electric motor EM1 is operated as a generator such that the cumulative torque of the internal combustion engine 2 and of the first electric motor EM1 is approximately equal to 0, while the second electric motor EM2 applies the torque at the drive output. The torque reduction or increase takes place linearly in each case. As a result, the gearshift clutch A becomes load-free and is disengageable.

Thereafter, the first electric motor EM1 and the internal combustion engine 2 synchronize the first transmission input shaft 7, via which no torque is transmitted in this moment, with respect to the second transmission input shaft 9, and so the third clutch K3 is engageable. Finally, a load change from the second electric motor EM2 to the internal combustion engine 2 takes place, as the result of which the second internal-combustion-engine forward gear V2 is achieved. In the second internal-combustion-engine second forward gear V2, the second gearshift clutch B is engaged. Therefore, the second electric motor EM2 is operable as a generator in this case, provided the second gearshift clutch B is to be disengaged again.

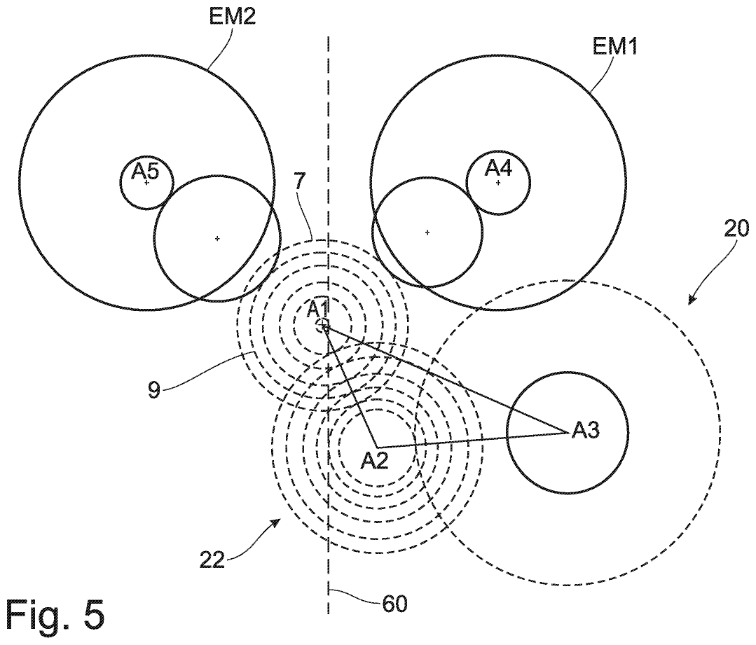

FIG. 5 shows a side view of the transmission according to FIG. 2. A fourth axis A4 corresponding to the first electric motor EM1 and a fifth axis corresponding to the second electric motor EM2 are arranged above and laterally with respect to the first axis A1 of the first transmission input shaft 7 and also of the second transmission input shaft 9. The second axis A2 of the countershaft 22 and a third axis A3 of the differential are advantageously situated below the first axis A1 of the first transmission input shaft 7. The fourth and fifth axes A4, A5 are arranged symmetrically with respect to the first axis A1 such that the distance of the fourth and fifth axes A4, A5 to the first axis A1 is identical and the angle with respect to the perpendicular 60 is also identical.

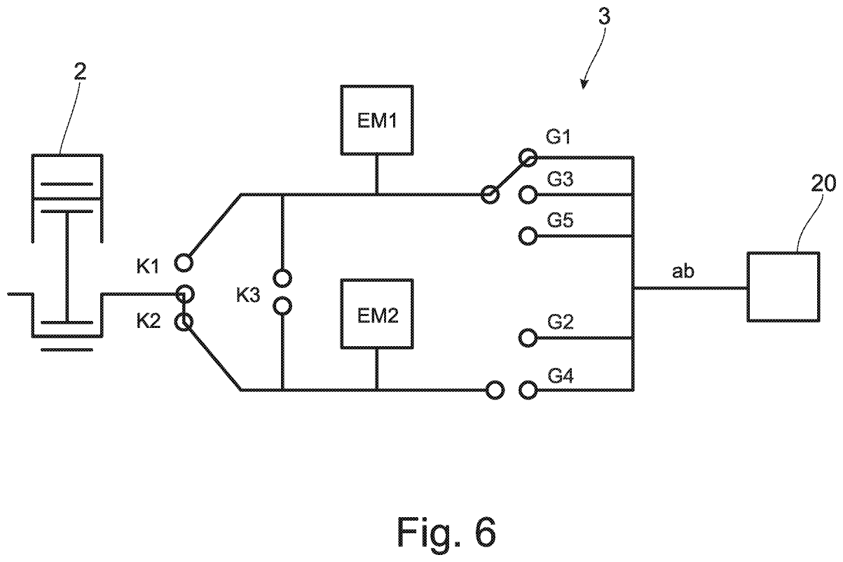

FIG. 6 shows the hybrid transmission device 3 and the motor vehicle 1 as a circuit diagram in the crawler gear, wherein the first electric motor EM1 is utilized not only as a main drive source, but rather as the sole drive source of the motor vehicle 1. The first gearshift clutch A is engaged. The first gear step G1 is therefore provided for transmitting torque to the drive output. Since the first electric motor EM1 is the drive source, this is equivalent to the utilization of the electric gear E1. Due to the engagement of the second clutch K2, the internal combustion engine 2 can drive the second electric motor EM2. The second electric motor EM2 is therefore operated as a generator and, in this way, generates current for inching operations of longer duration. Neither the internal combustion engine 2 nor the second electric motor EM2 are connected to the drive output in this case.

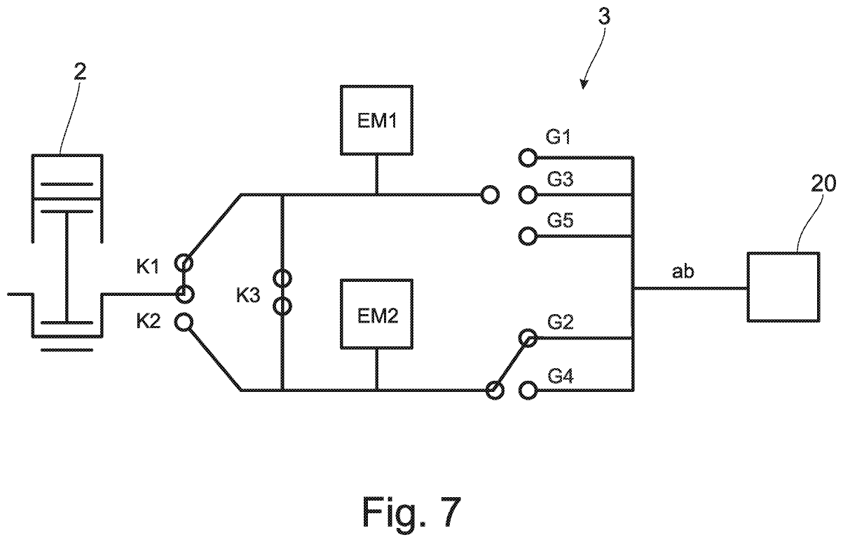

FIG. 7 shows a hybrid gear H22, in which the internal combustion engine 2 and also the second electric motor EM2 are connected to the drive output via the gear-step gears 12, 26 of the second gear step G2. The third clutch K3 is engaged in order to connect the internal combustion engine 2 to the gear-step gears 12, 26. Due to the engaged first clutch K1, the first electric motor EM1 is also connected to the internal combustion engine 2 and is operated as a generator, as necessary. A portion of the power of the internal combustion engine 2 is therefore utilized for the operation of the first electric motor EM1 as a generator and a portion is output to the drive output of the hybrid transmission device 3.

The first electric motor EM1 does not need to be continuously operated as a generator, as described. Rather, a change-over is optional between the electric motors EM1, EM2.

With regard to the nomenclature, the first number of the hybrid gear designates the internal-combustion-engine gear and the second number designates an electric motor-operated gear. It is not expressed whether the first electric motor EM1 is operated as a motor or as a generator, for example, in the hybrid gear H32.

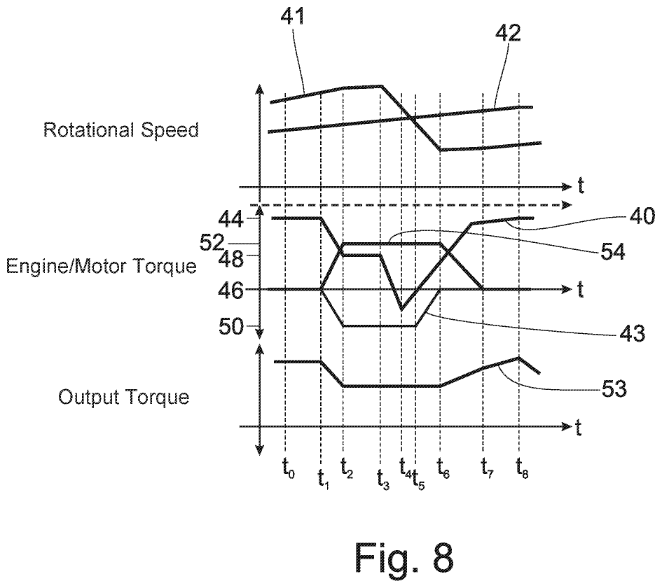

FIG. 8 shows a representation of a gear change from the hybrid gear H22 to the hybrid H32 over time. A change-over from the second internal-combustion-engine gear V2 to the third internal-combustion-engine gear V3 is therefore carried out, while the second electric-motor gear E2 remains present.

Rotational speeds are represented in the upper section, engine/motor torques are represented in the middle section, and the output torque is represented in the lower section.

At the point in time t₀, a gear shift is present as shown in FIG. 7. The internal combustion engine 2 and the second electric motor EM2 provide output via the gear-step gears of the second gear to the drive output. An engine/motor speed 41 of the internal combustion engine 2 and of the first electric motor EM1 coupled thereto and a motor speed 42 of the second electric motor EM2 are at their initial values. Due to a request for a gear change, at the point in time t₁, the engine torque 40 of the internal combustion engine 2 is reduced. Simultaneously, the motor torque 43 of the first electric motor EM1 extends below 0, as the first electric motor EM1 is operated as a generator. The initial values 44, 46 of the engine torque 40 of the internal combustion engine 42 and the motor torque 43 of the first electric motor EM1 are reduced to the target values 48, 50, respectively, by the point in time t₂.

In addition, at the point in time t₁, the motor torque 54 of the second electric motor EM2 begins to ramp up, starting from its initial value of 0, to a target value 52. If the target values 48, 50 are selected such that they have the same amount or magnitude, this means the cumulative torque of the internal combustion engine 2 and the first electric motor EM1 is equal to 0, as the result of which the third clutch K3 becomes load-free and is disengageable. Disengagement of the third clutch K3 takes place between the points in time t₂ and t₃.

In this interval, i.e., between the points in time t₂ and t₃, only the second electric motor EM2 drives the motor vehicle 1, since the torques of the internal combustion engine 2 and the first electric motor EM1 cancel each other out as described. Starting at the point in time t₃, the torque 40 of the internal combustion engine is reduced further in order to bring the rotational speed of the transmission input shaft 7 to the rotational speed, at which a ratio with respect to the rotational speed of the countershaft 22 is reached, at which the gearshift clutch C is engageable.

Between the points in time t₂ and t₆, in which only or mainly the second electric motor EM2 drives, the output torque 53 (e.g., the torque supplied to the transmission) is lower than in the case of an assistance or take-over by the internal combustion engine 2.

Starting at the point in time t₅, the generator operation of the first electric motor EM1 begins to end. The first electric motor EM1 is ramped up to its initial value and/or the initial torque 46. Simultaneously, the engine torque 40 of the internal combustion engine 2 is also increased to its initial value 44. As soon as the first electric motor EM1 has ended the operation as a generator at the point in time t₆, the torque output of the second electric motor EM2 is reduced and, in fact, also back to the initial value. At the point in time t₇, the torque output of the electric motors EM1, EM2 is at the initial value again. The torque output of the internal combustion engine 2 is increased slightly up to the point in time t₈.

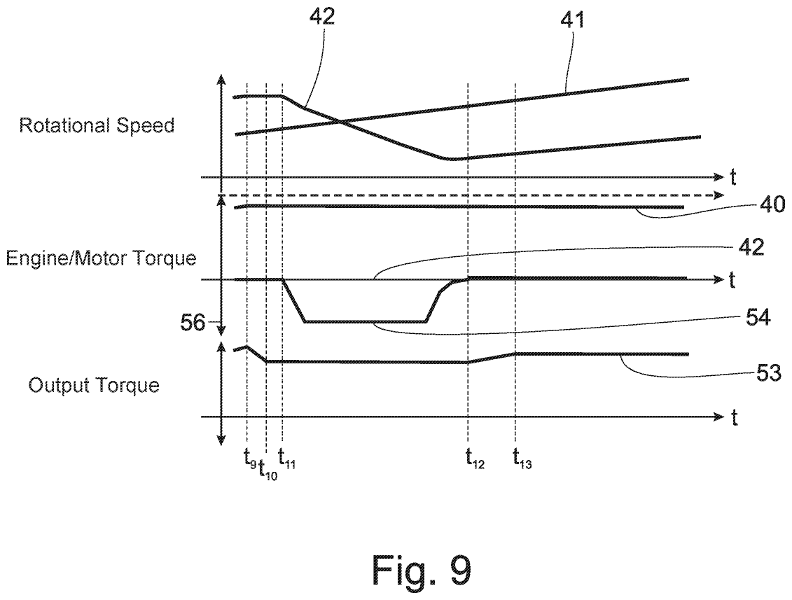

FIG. 9 shows the gear change of a hybrid gear starting from the third internal-combustion-engine gear V3 and the second electric-motor gear E2 into the fourth electric-motor gear E4. At the point in time t₉, the shift elements are located as they are at the point in time t₈, i.e., only the rotational speeds 41, 42 may have changed. At the point in time t₁₀, the second gearshift clutch B is disengaged. The disengagement has ended by the point in time t₁₁. Starting at time t₁₁, the motor torque 54 of the second electric motor EM2 is guided to a negative value, in order to adapt, by operating as a generator, the rotational speed of the transmission input shaft 9 to the rotational speed of the transmission input shaft 7 such that the idler gear 24 has the same rotational speed as the shift element 52. The rotational speeds of the transmission input shaft 7 and of the transmission input shaft 9 are therefore not to become identical, but rather are to be adapted such that the rotational speeds of the idler gear 24 and of the second engagement device S2 are identical or are identical except for a predefined difference. Thereupon, starting at the point in time t₁₂, the gearshift clutch D is engageable, as the result of which the second electric motor EM2 outputs torque to the drive output via the gear-step gears of the fourth gear G4. At the point in time t₁₃, the fourth gearshift clutch D is engaged. Starting at this point in time, the internal combustion engine 2 transmits its torque via the gear-step gears of the third gear G3 and the second electric motor EM2 transmits its torque via the gear-step gears of the fourth gear. The curve 53 of the output torque shows only a slight downturn, since the gear change of the second electric motor EM2 is assisted by the internal combustion engine 2 in the time period between the points in time t₁₁ and t₁₂, in which no torque from the second electric motor EM2 reaches the drive output.

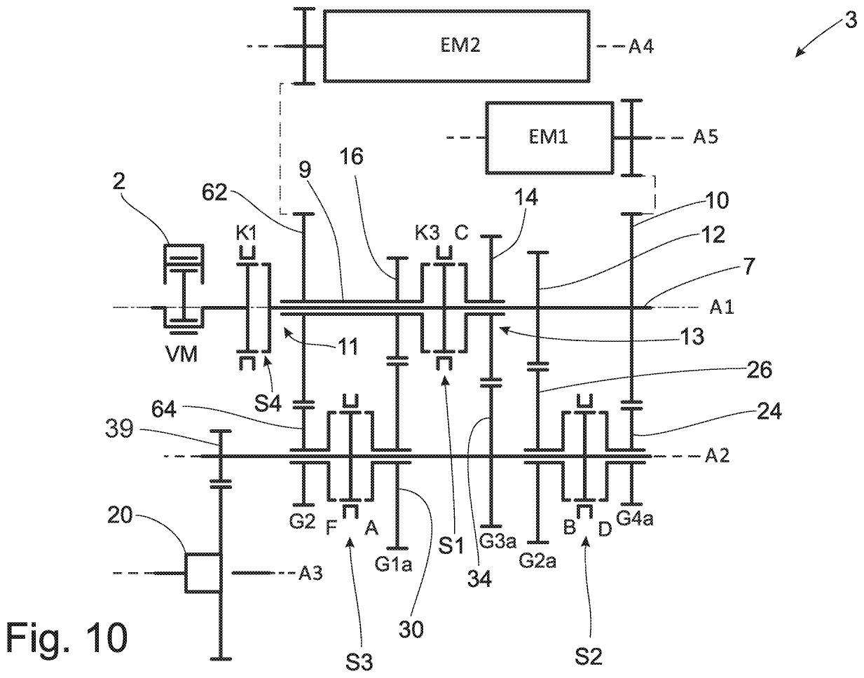

FIG. 10 shows a configuration as an alternative to FIG. 2, wherein most features and functions are similar to those described with respect to FIGS. 2 through 9. Identical reference numbers label identical components. For instance, the first transmission input shaft, which is a solid shaft, also has, for example, the reference character 7. Similarly, the second transmission input shaft, which is a hollow shaft, has the reference character 9.

In contrast to FIG. 2, however, the second clutch K2 and the gear-step gears 18, 32 of the fifth gear step G5 are omitted. In their place, the gear-step gears 62, 64 of a purely electrically utilized gear step GE2 have been added. While most of the gears labeled with a “G” are electric, internal-combustion-engine, and/or hybrid gear steps, the gear step GE2 is limited to an electric gear step.

The crawler gear E1 is implemented via the gear step G1, wherein, in the embodiment according to FIG. 10, the second transmission input shaft 9 and the second electric motor EM2 are utilized as a drive.

The electric motors EM1, EM2 are power shiftable with one another in the configuration of FIG. 10 as well.

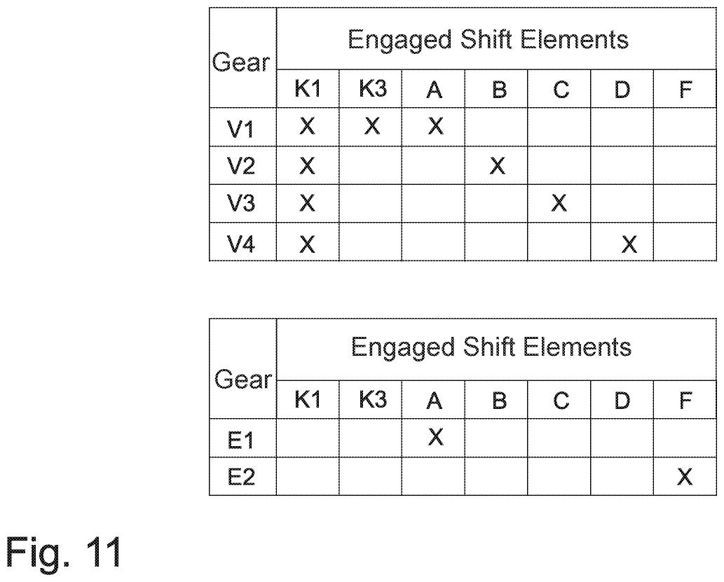

In contrast to FIGS. 2-4, however, only four internal-combustion-engine forward gears V1, V2, V3, and V4 can be implemented, as shown in FIG. 11. The internal-combustion-engine forward gears V1, V2, V3, and V4 and the electric forward gear E1 are formed via the corresponding mechanical gear stages G1, G2, G3, and G4, i.e., E1 and V1 with G1, V2 with G2, etc. The electric gear E2 has separate gear-step gearwheels 62 and 64, however, and does not utilize the gear-step gearwheels 12 and 26 of the gear step G2, which, at this point, deviates from the nomenclature utilized otherwise in the present application.

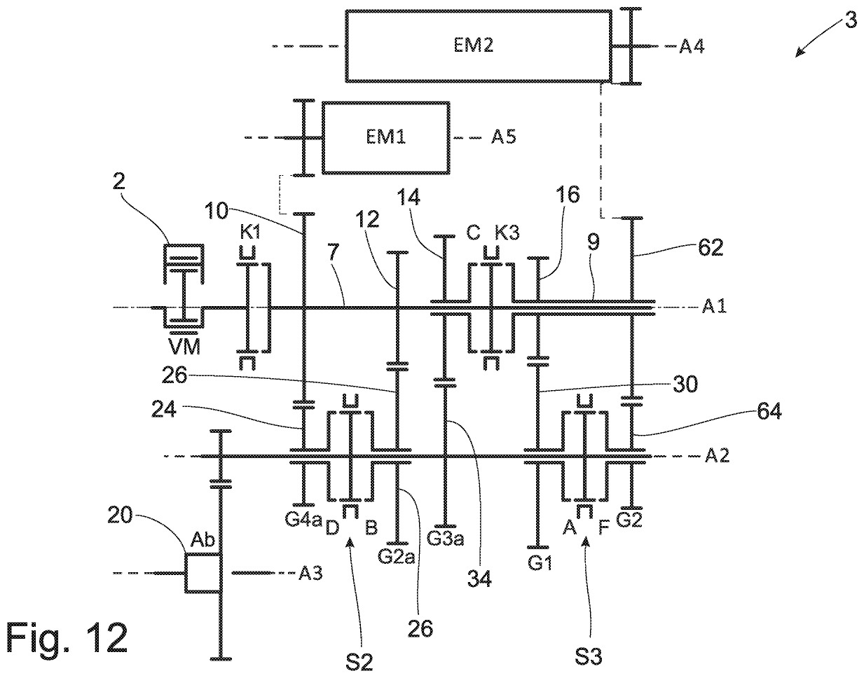

FIG. 11 shows a corresponding shift pattern, which is associated with FIGS. 10 and 12. The particular engaged shift elements are marked by “X”.

The sixth gearshift clutch F is the shift element of the gear step GE2, which is utilized only with the second electric motor EM2.

FIG. 12 shows a mirror image of the hybrid transmission device 3 according to FIG. 10 with respect to the central axis, which extends through the gearwheels 14, 34 of the gear step G3. From a purely functional perspective, the hybrid transmission devices 3 according to FIGS. 10 and 12 do not differ.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 motor vehicle
2 internal combustion engine
3 hybrid transmission device
4 gear set
5 crankshaft
6 output part
7 first transmission input shaft
8 output part
9 second transmission input shaft
10 first fixed gear
11 first end
12 second fixed gear
13 second end
14 third idler gear
15 control device
16 fourth fixed gear
18 fifth fixed gear
20 differential
22 countershaft
24 first idler gear
26 second idler gear
30 fourth idler gear
31 output shaft
32 fifth idler gear
33 output shaft
34 third fixed gear
35 end facing away from the motor
36 sub-transmission
37 end facing the motor
38 sub-transmission
39 sixth fixed gear
40 curve
41 engine/motor speed
42 motor speed
43 curve
44 initial value
46 initial value
48 target value
50 target value
52 target value
53 output torque
54 curve
60 perpendicular
K1 first clutch
K2 second clutch
K3 third clutch
S1 first engagement device
S2 second engagement device
S3 third engagement device
S4 fourth engagement device
A first gearshift clutch
B second gearshift clutch
C third gearshift clutch
D fourth gearshift clutch
E fifth gearshift clutch
F sixth gearshift clutch
EM1 first electric motor
EM2 second electric motor
A1 first axis
A2 second axis
A3 third axis
A4 fourth axis
A5 fifth axis
V1 first internal-combustion-engine gear
V2 second internal-combustion-engine gear
V3 third internal-combustion-engine gear
V4 fourth internal-combustion-engine gear
V5 fifth internal-combustion-engine gear

1-15: (canceled)

16. A hybrid transmission device (3), comprising:
at least one drive device (EM1, EM2);
a first transmission input shaft (7);
a second transmission input shaft (9) mounted on the first transmission input shaft;
a first clutch (K1); and
a connecting clutch (K3) actuatable to rotationally fix the first transmission input shaft (7) to the second transmission input shaft (9),
wherein the first transmission input shaft (7) is connected to an output (6) of the first clutch (K1),
wherein the at least one drive device (EM1, EM2), the connecting clutch (K3), and the first transmission input shaft (7) are connectable to an internal combustion engine (2) via actuation of the first clutch (K1), and
wherein the first clutch (K1) is a dog clutch.

17. The hybrid transmission device of claim 16, wherein the second transmission input shaft (9) has a first end (11) proximate an outer side of the hybrid transmission device (3) and a second end (13) proximate an inner side of the hybrid transmission device (3),
the hybrid transmission device further comprising a second clutch (K2) actuatable to connect the second transmission input shaft (9) to the internal combustion engine (2), the second clutch (K2) being proximate the first end (11) of the second transmission input shaft (9).

18. The hybrid transmission device of claim 17, further comprising gearshift clutches (A, B, C, D, E),
wherein one or more of the first clutch (K1), the second clutch (K2), the connecting clutch (K3), and the gearshift clutches (A, B, C, D, E) is a dog clutch.

19. The hybrid transmission device of claim 16, wherein the second transmission input shaft (9) has a first end (11) proximate an outer side of the hybrid transmission device (3) and a second end (13) proximate an inner side of the hybrid transmission device (3), and
wherein the connecting clutch (K3) is proximate the second end (13) of the second transmission input shaft (9).

20. The hybrid transmission device of claim 19, further comprising gearshift clutches (A, B, C, D, E),
wherein one or more of the first clutch (K1), the connecting clutch (K3), and the gearshift clutches (A, B, C, D, E) is a dog clutch.

21. The hybrid transmission device of claim 16, wherein the connecting clutch (K3) is part of a two-sided engagement device (S1).

22. The hybrid transmission device of claim 16, wherein the at least one drive device (EM1, EM2) includes at least a first drive device (EM1) and a second drive device (EM2), the first drive device (EM1) being associated with the first transmission input shaft (7), the second drive device (EM2) being associated with the second transmission input shaft (9).

23. The hybrid transmission device of claim 16, wherein the hybrid transmission device (3) includes precisely four two-sided engagement devices (S1, S2, S3, S4), five internal-combustion-engine forward gears (V1, V2, V3, V4, V5) being engageable via selective actuation of two or more of the four two-sided engagement devices (S1, S2, S3, S4).

24. The hybrid transmission device of claim 16, wherein the connecting clutch (K3) is mounted on the first transmission input shaft (7).

25. The hybrid transmission device of claim 16, wherein precisely two engagement devices (S1, S4) are arranged on the first transmission input shaft (7).

26. The hybrid transmission device of claim 16, wherein the hybrid transmission device (3) includes precisely one countershaft (22).

27. The hybrid transmission device of claim 26, wherein precisely two engagement devices (S2, S3) are arranged on the countershaft (22).

28. The hybrid transmission device of claim 26, wherein precisely one fixed gear (34) for forming a forward gear step (G3) is arranged on the countershaft (22).

29. The hybrid transmission device of claim 16, wherein each of the at least one drive device (EM1, EM2) is rotatably coupled to a respective fixed gear (10, 18).

30. The hybrid transmission device of claim 16, further comprising at least one axially external gear-step gear (10, 18),
wherein the first and the second transmission input shafts (7, 9) are rotatable about a common axis A1,
wherein each of the at least one axially external gear-step gear (10, 18) is rotatable about the common axis (A1), and
wherein each of the at least one axially external gear-step gear (10, 18) being a fixed gear.

31. A motor vehicle (1) comprising the hybrid transmission device (3) of claim 16.
